(19) United States
(12) Patent Application Publication
(10) Pub. No.: US 2008/0041395 A1
(43) Pub. Date: Feb. 21, 2008

(54) Method for alleviating or diverting pressure, treating or preventing the formation of sleep lines or decreasing their rate of formation, decreasing the rate of scar formation or facilitating the overall healing of a target area of a subjects's body

(76) Inventors: Judith E. Tytel, Syosset, NY (US); Christine Didonato, West Chester, PA (US)

Correspondence Address: FULBRIGHT & JAWORSKI, LLP, 666 FIFTH AVE, NEW YORK, NY, 10103-3198, US

(21) Appl. No.: 11/807,821

(22) Filed: May 30, 2007

Related U.S. Application Data
(60) Provisional application No. 60/810,477, filed on Jun. 2, 2006.

(51) Int. Cl. A61G 15/00

(52) U.S. Cl. 128/845

(57) ABSTRACT

The present invention relates to a method of using a support device such as a pillow, where the support device is designed to support and adapt to the shape of a body part or portion requiring support, so as to, e.g., alleviate or divert pressure, treat or prevent formation of sleep lines or decrease their rate of formation, decrease the rate of scar formation, or facilitate the overall healing of a target area of a subject's body when the subject is resting or sleeping.

### RELATED APPLICATION

This application claims priority benefit under Title 35 U.S.C. §119(e) of U.S. provisional patent application No. 60/810,477, filed Jun. 2, 2006, incorporated by reference in its entirety.

### FIELD OF THE INVENTION

The present invention relates to a method of using a support device such as a pillow, especially a device that is designed in an appropriate shape, such as a device designed to support and adapt to the shape of a body part or portion requiring support, so as to, e.g., alleviate or divert pressure, treat or prevent formation of sleep lines (or wrinkles) or decrease their rate of formation, decrease the rate of scar formation, or facilitate the overall healing of a target area of a subject's body when the subject is resting or sleeping.

### BACKGROUND OF THE INVENTION

Pressure on a target area of a subject's body during sleep or rest can either cause or aggravate certain problems experienced by the subject. These problems include, but are not limited to, the formation or aggravation of sleep lines or wrinkles (including caused by pressure during sleeping or resting) in a subject's face. (Hereinafter, the term “sleep lines” will be used generically, and it is understood to include the term “wrinkles” and other terms which will be familiar to the skilled artisan, and need not be reiterated here.)

Sleep lines are specific lines caused by pressure on a subject's face, and the formation of such lines is related, in part, to sleep or rest position. They occur over time eventually becoming deeper and permanently etched in the face, and may become more visible after skin starts losing its elasticity. These lines sometimes occur as single and sometimes as multiple units, generally in the same area of the face. Pressure creates and aggravates the formation and depth of these lines, which are accentuated by nightly pillow, mattress, or other support contact when subjects sleep on their sides or sleep in a prone (face down) position.

Treating or preventing the formation of sleep lines, or decreasing their rate of formation, is desirable for many reasons which will be familiar to the skilled artisan, and need not be reiterated here. No drug based therapies or interventions, however, have been proven to be effective in treating or preventing the formation of sleep lines or decreasing their rate of formation, for any extended period of time. Thus, an effective way of doing so is needed, and the only approach available to one who would in fact try to alleviate these problems is to, so to speak, “nip them in the bud,” i.e., attack the root cause of the problem, which is the pressure resulting from placement of the face or other body part on a support not designed to prevent or alleviate the problem.

Additionally, while in some therapeutic contexts pressure is beneficial and indicated for a portion of a subject's body undergoing healing, in other situations it is known that the application of unintended non-therapeutic pressure on a target area of a subject's body undergoing healing inhibits the body's ability to heal at a normal rate and can also increase the rate of scar formation. The present application addresses the situations where non-therapeutic pressure (hereinafter referred to generically as “pressure”) is being applied.

Scar formation, which is a natural part of the body's healing process when skin or other body tissue is damaged (as a result of, e.g., injury, infection, inflammation, or post-surgical complication), and, for that matter, the overall healing of a damaged area, are aggravated by pressure on the affected area and may be accompanied by a decrease in blood flow. Such pressure occurs, for example, when a subject is resting or sleeping and the affected area is positioned on a pillow or mattress or other support not designed to alleviate the problem. Notwithstanding this, bed rest or some other form of rest is frequently a part of standard therapies associated with these conditions, and proper sleep is also a sine qua non of the healing process.

Decreasing the rate of scar formation on a target area of a subject's body is desirable for both therapeutic and cosmetic reasons. For example, scar tissue is less resistant to ultraviolet radiation and is thicker and paler than tissue surrounding the scar. It is advantageous to decrease the rate of scar formation which, in turn, would limit the extent of affected skin that would be thicker, paler, and less resistant to ultraviolet radiation. Thus, an effective way of decreasing the rate of scar formation on a target area of a subject's body is needed. Relieving pressure on the target area, or diverting pressure therefrom, where scar tissue is forming, during sleep or rest, and altering the subject's sleeping or resting position is one effective way of doing so. This alleviation or diversion of pressure increases blood flow to the target area where scar tissue is forming, and, thus, helps decrease the rate of scar formation.

The facilitation of the overall healing of a target area of a subject's body is desirable for countless reasons which will be familiar to the skilled artisan, and need not be reiterated here. This facilitation of overall healing can be based on the same premise of alleviating or diverting pressure. Thus, an effective way of facilitating the healing of the target area of a subject's body is needed which relieves pressure on such an area, during sleep or rest, and which alters the subject's sleeping or resting position. This alleviation or diversion of pressure aids the desired increase in blood flow to the target area of a subject's body, and, thus, facilitates healing of the target area.

It is desirable to have a method of using a support device to alleviate or divert pressure, treat or prevent formation of sleep lines or decrease their rate of formation, decrease the rate of scar formation, and facilitate the overall healing of a target area of a subject's body when the subject is resting or sleeping.

### OBJECTS AND SUMMARY OF THE INVENTION

An object of the present invention is to provide a method of using a support device to alleviate pressure on a target area of a subject's body, or divert pressure therefrom, when the subject is resting or sleeping.

An additional object of the present invention is to provide a method of using a support device to treat or prevent the formation of sleep lines, or decrease their rate of formation, on a target area of a subject's body, by decreasing pressure on such area when the subject is resting or sleeping.

A further object of the present invention is to provide a method of using a support device to decrease the rate of scar formation on a target area of a subject's body, by decreasing pressure on such area when the subject is resting or sleeping.

Still another object of the present invention is to provide a method of using a support device to facilitate the overall healing of a target area of a subject's body, by decreasing pressure on such area when the subject is resting or sleeping.

In accordance with an embodiment of the present invention, a method of using a support device such as a pillow, especially a device that is designed in an appropriate shape, such as a device designed to support and adapt to the shape of a body part or portion requiring support, is provided to alleviate or divert pressure, treat or prevent formation of sleep lines or decrease their rate of formation, decrease the rate of scar formation, and facilitate the overall healing of a target area of a subject's body, when the subject is resting or sleeping.

Other objects and features of the invention will become apparent from the following description relating to the accompanying drawing, showing the preferred form. The essential characteristics are summarized in the claims.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the specific concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figure. It is to be expressly understood, however, that the figure is provided for the purpose of illustration and description only and is not intended as a definition of the limits of the present invention.

### BRIEF DESCRIPTION OF THE DRAWING

For a more complete understanding of the present invention, reference is now made to the following description taken in conjunction with the accompanying drawing, in which:

FIG. 1 is a perspective view of a support device typical of the type used in the method disclosed herein.

### DESCRIPTION OF THE EMBODIMENTS

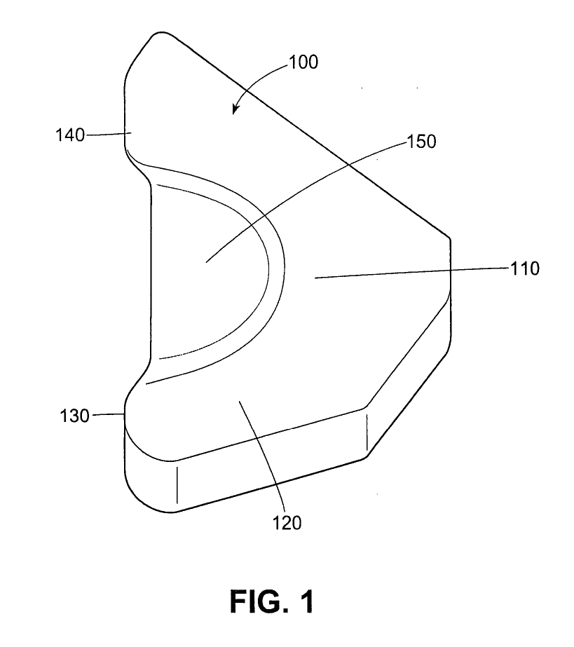

Turning to FIG. 1, there is illustrated a support device 100, in accordance with an embodiment of the present invention. The support device 100 illustrated in FIG. 1 is designed to support and adapt to the shape of a portion of a person's face requiring support. The support device 100 is also designed to alleviate pressure on the target area of a subject's face, or divert the pressure from the target area to the firmer, more stable structures of the subject's head.

The corresponding anatomical supporting portions of the support device 100 should be positioned between an area proximate to a target area of the subject's face, e.g., the subject's: ear should be placed on the subject's ear portion 110, jaw line should be placed on the jaw line portion 120, mouth should be placed on the mouth portion 130, and eye should be placed on the eye portion 140, and a preferably flat surface during a time when the subject is resting or sleeping. The support device also contains a concavity 150, which does not contact any part of the subject's face, or if there is contact with the concavity 150, this part of the support device does not support nor put any significant pressure on the point of contact. When the support device 100 illustrated by FIG. 1 is used by a subject, the concavity 150 is adjacent to the subject's cheek area, which is the “target area” in this embodiment of the present invention. The “target area” is discussed infra.

The target area can include an area where it is desirable to treat or prevent the formation of sleep lines, or decrease their rate of formation. The target area may also include an area where it is desirable to decrease the rate of scar formation or facilitate the overall healing, where, for example, an injury, infection, or inflammation has occurred, or surgery has been performed. It can also be used in connection with disease symptoms.

The supporting portions of the device distribute the support of the device away from the target area to the proximate area, thereby alleviating pressure on the target area and diverting the pressure to the proximate area. For example, positioning the supporting portions of the support device 100 of the present invention as discussed supra, removes pressure from the skin and underlying muscle in the target area, e.g., the eye, cheek and chin area, or the face in general, where sleep lines are most likely to occur, and diverts or distributes it to the area proximate to the target area, e.g., surrounding facial bones, where the formation of sleep lines is not an issue.

In accordance with an embodiment of the present invention, this alleviation of pressure on the target area portion of the subject's face (and diversion of the pressure to the proximate areas) when the subject rests or sleeps helps to treat or prevent the formation of sleep lines on a subject's face, or to decrease their rate of formation. This alleviation (and diversion) of pressure on a target area of the subject's face also prevents a decrease in blood flow to the subject's face, and, thus, can help decrease the rate of scar formation and facilitate healing of a target area of the subject's face.

Other shapes of the support device of the present invention, which are not shown by the figure, are contemplated in response to a need for added comfort or to a use on a different part or portion of a subject's body, or to accommodate varying facial sizes. Additionally, a ring-shaped support device is contemplated, which is not shown by the figure. These alternate embodiments will be immediately clear to the skilled artisan. (See, e.g., U.S. Pat. Nos. 2,085,296; 6,190,487; 3,848,281; 6,625,831; 4,617,691; 2,336,707; and 4,768,246).

In accordance with an embodiment of the present invention, the support device, such as a pillow or other embodiment, is preferably hypoallergenic. Further, the pillow or other embodiment is preferably made of a removable machine washable outer cover and an inner material. The outer cover of the pillow or other embodiment is preferably made of satin or silk (i.e., materials that minimize friction upon contact with the target area, which are known to those of ordinary skill in the art), but can also be made of a synthetic material or cotton. The inner material can be made of natural, synthetic, and/or organic, or ergonomic material. The inner material is preferably made of at least one of the following materials: foam, foam rubber, memory foam, polyester, siliconized polyester, cotton or down wrapped core of foam, or other shape retaining material.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A method of using a support device, wherein said support device is designed to support and adapt to the shape of a body part or portion requiring support, to alleviate pressure on a target area of a subject's body, or divert pressure from said target area, when said subject is resting or sleeping, comprising:
positioning at least one supporting portion of said support device between a substantially flat surface and an area proximate to said target area; and
distributing said support device's support away from said target area and to said proximate area, thereby alleviating the pressure on said target area, or diverting said pressure from said target area.

2. The method of claim 1, wherein said target area is an area comprising said subject's face, and wherein said positioning comprises positioning said at least one supporting portion of said support device on a body area, so as to treat or prevent the formation of sleep lines on said face, or to decrease said sleep lines' rate of formation.

3. The method of claim 2, wherein said target area is an area comprising a part of said subject's face, selected from the group consisting of: cheek, chin, forehead, eyes, mouth, lips, or neck, and wherein said positioning comprises positioning said at least one supporting portion of said support device on a facial area proximate to said cheek, chin, forehead, eyes, mouth, lips, or neck, thereby treating or preventing the formation of sleep lines on said cheek, chin, forehead, eyes, mouth, lips, or neck, or decreasing said sleep lines' rate of formation.

4. The method of claim 3, wherein said target area is an area comprising said subject's chin, and wherein said positioning comprises positioning said at least one supporting portion of said support device on a facial area proximate to said chin, thereby treating or preventing the formation of sleep lines on said chin, or decreasing said sleep lines' rate of formation.

5. The method of claim 3, wherein said target area is an area around an eye of said subject, and wherein said positioning comprises positioning said at least one supporting portion of said support device on a facial area proximate to said area around said eye, thereby treating or preventing the formation of sleep lines on said area around said eye, or decreasing said sleep lines' rate of formation.

6. The method of claim 1, wherein said target area suffers from an injury, inflammation, infection, or post-surgical complication, and wherein said positioning comprises positioning said at least one supporting portion of said support device on an area proximate to said target area, thereby decreasing the rate of formation of scar tissue on said target area.

7. The method of claim 1, wherein said target area suffers from an injury, inflammation, infection, or post-surgical complication, and wherein said positioning comprises positioning said at least one supporting portion of said support device on an area proximate to said target area, thereby facilitating healing of said target area.

8. The method of claim 6, wherein said target area is an area of said subject's face which has undergone cosmetic or reconstructive surgery, and wherein said positioning comprises positioning said at least one supporting portion of said support device on an area proximate to said area of said subject's face which has undergone cosmetic or reconstructive surgery, thereby decreasing the rate of formation of scar tissue on said area of said subject's face which has undergone cosmetic or reconstructive surgery.

9. The method of claim 7, wherein said target area is an area of said subject's face which has undergone cosmetic or reconstructive surgery, and wherein said positioning comprises positioning said at least one supporting portion of said support device on an area proximate to said area of said subject's face which has undergone cosmetic or reconstructive surgery, thereby facilitating healing of said area of said subject's face which has undergone cosmetic or reconstructive surgery.

10. The method of claim 1, wherein said support device is a pillow.

11. The method of claim 10, wherein said pillow is hypoallergenic.

12. The method of claim 10, wherein said pillow comprises an outer cover and an inner material.

13. The method of claim 12, wherein said outer cover is removable and is machine washable.

14. The method of claim 12, wherein said outer cover comprises satin or silk.

15. The method of claim 12, wherein said outer cover comprises cotton or synthetic material.

16. The method of claim 12, wherein said inner material comprises organic material.

17. The method of claim 12, wherein said inner material comprises natural material.

18. The method of claim 12, wherein said inner material comprises synthetic material.

19. The method of claim 12, wherein said inner material comprises a shape retaining material.

20. The method of claim 19, wherein said shape retaining material comprises foam rubber, polyester, siliconized polyester, cotton, memory foam, or a down wrapped core of foam.

21. The method of claim 12, wherein said inner material is an ergonomic material.
